(19) United States
(12) Patent Application Publication
(10) Pub. No.: US 2007/0273478 A1
(43) Pub. Date: Nov. 29, 2007

(54) Automotive latch and RF system interfacing

(76) Inventor: John Phillip Chevalier, London (GB)

Correspondence Address: DICKSTEIN SHAPIRO LLP, 1825 EYE STREET NW, Washington, DC, 20006-5403, US

(21) Appl. No.: 11/441,210

(22) Filed: May 26, 2006

(51) Int. Cl. B60R 25/00

(52) U.S. Cl. 340/5.72; 340/5.64

(57) ABSTRACT

A keyless entry method, system and program product is disclosed herein. In general, user command information can be transmitted to a receiving and transmitting unit which communicates with a latch. A processor can then process the user command information utilizing a processor, which communicates the latch and the receiving and transmitting unit. The latch can thereafter be instructed to perform a particular latch function (e.g., opening or closing a vehicle door), in response to processing the user command information utilizing the processor.

### TECHNICAL FIELD

Embodiments are generally related to door latch assemblies, including door latching mechanisms utilized in automobiles and other vehicles. Embodiments are also related to techniques for automatically and remotely controlling vehicle door latches. Embodiments are also related to keyless entry systems for vehicles.

### BACKGROUND OF THE INVENTION

Latching mechanisms are utilized in a variety of commercial and industrial applications, such as automobiles, airplanes, trucks, and the like. For example, an automotive closure, such as a door for an automobile passenger compartment, is typically hinged to swing between open and closed positions and conventionally includes a door latch that is housed between inner and outer panels of the door. The door latch functions in a well-known manner to latch the door when it is closed and to lock the door in the closed position or to unlock and unlatch the door so that the door can be opened manually.

The door latch can be operated remotely from inside the passenger compartment by two distinct operators—a sill button or electric switch that controls the locking function and a handle that controls the latching function. The door latch is also operated remotely from the exterior of the automobile by a handle or push button that controls the latching function. A second distinct exterior operator, such as a key lock cylinder, may also be provided to control the locking function, particularly in the case of a front vehicle door. Each operator is accessible outside the door structure and extends into the door structure where it is operatively connected to the door latch mechanism by a cable actuator assembly or linkage system located inside the door structure.

Vehicles, such as passenger cars, are therefore commonly equipped with individual door latch assemblies which secure respective passenger and driver side doors to the vehicle. Each door latch assembly is typically provided with manual release mechanisms or lever for unlatching the door latch from the inside and outside of the vehicle, e.g. respective inner and outer door handles. In addition, many vehicles also include an electrically controlled actuator for remotely locking and unlocking the door latches.

Automotive latches are increasingly being adapted for utilization with keyless entry systems. Keyless entry systems for vehicles allow users to lock or unlock the doors of a vehicle without a key. Keyless entry systems typically take the form of pocket-sized devices (e.g., a keychain) with several push buttons that lock and unlock doors and perform other functions through encoded RF signals transmitted to a vehicle-installed receiver.

Keyless entry systems are a great convenience to users. With a keyless entry system, a user, whose hands are burdened, can easily lock or unlock the doors of a vehicle. Keyless entry systems also allow a user to ensure that the doors are locked as the user walks away from the vehicle, and to escape harm by unlocking the doors quickly to gain entry into the vehicle when confronted by an assailant or otherwise threatened. Some keyless entry systems allow the user to activate an alarm and transmit a call for help. Further, keyless entry systems enable the user to locate a vehicle in a crowded parking lot by unlocking and relocking the doors, thereby causing the vehicle to sound its horn or flash its lights. Because of the many benefits, keyless entry systems have become standard equipment on many new vehicles.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for an improved latch control and diagnostic mechanism.

It is another aspect of the present invention to provide for improved latching systems and methods for use in automobiles and other vehicles.

It is yet a further aspect of the present invention to provide for an improved to keyless entry systems for an automotive vehicle.

It is an additional aspect of the present invention to provide for an integrated latch and keyless entry system.

The aforementioned aspects of the invention and other objectives and advantages can now be achieved as described herein. A keyless entry method, system and program product is disclosed herein. In general, user command information can be transmitted to a receiving and transmitting unit which communicates with a latch. A processor can then process the user command information utilizing a processor, which communicates the latch and the receiving and transmitting unit. The latch can thereafter be instructed to perform a particular latch function (e.g., opening or closing a vehicle door), in response to processing the user command information utilizing the processor.

Additionally, the user command information can be analyzed, and a verification test performed to determine if the user initiating the user command is a proper user, based on an analysis of the user command information. For example, if a particular user identifying code is identified among the transmitted user command information, the latch functionality instructions can then be processed. The receiving and transmitting unit can be integrated with the latch. The receiving and transmitting unit can be implemented as an RF/LF unit.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a vehicle door mounted to a passenger vehicle in which a preferred embodiment of the present invention can be implemented;

FIG. 2 illustrates a pictorial diagram of a keyless entry system, which can be adapted for use in accordance with a preferred embodiment of the present invention;

FIG. 3 illustrates a block diagram of a keyless RF/LF system, which can be implemented in accordance with a preferred embodiment of the present invention;

FIG. 4 illustrates a block diagram of a keyless RF/LF system, which can be implemented in accordance with an alternative embodiment of the present invention; and

FIG. 5 illustrates a high-level flow chart of operations depicting logical operational steps which can be implemented in accordance with a preferred embodiment of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

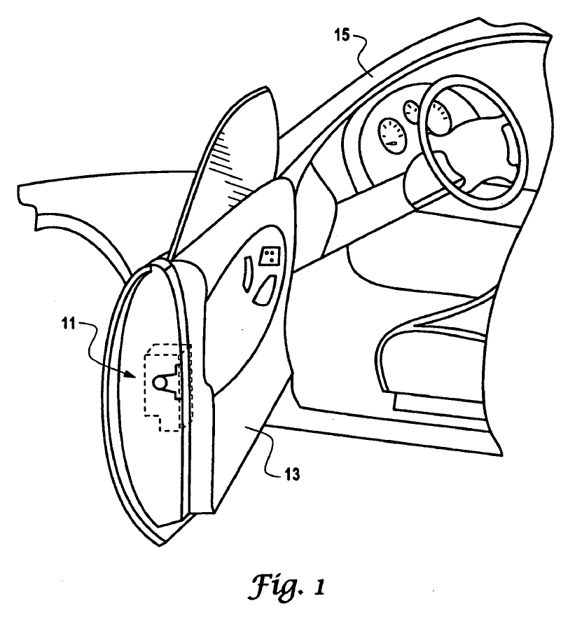

FIG. 1 illustrates a perspective view of a vehicle door 13 mounted to a passenger vehicle in which a preferred embodiment of the present invention can be implemented. A vehicle, such as an automobile can be equipped with one or more individual door latch assemblies 11, which secure respective passenger and driver side doors to the vehicle 15. Each door latch assembly 11 is typically provided with manual release mechanisms or lever for unlatching the door latch from the inside and outside of the vehicle, e.g. respective inner and outer door handles. In addition, many vehicles can also be equipped with electrically controlled actuators for remotely locking and unlocking the door latches. As indicated in FIG. 1, a door latch assembly 11 can be mounted to a driver's side vehicle door 13 of a passenger vehicle 15. The door latch assembly 11 may be mounted to front and rear passenger side doors thereof and may be incorporated into a sliding side door, rear door, a rear hatch or a lift gate thereof, depending upon design constraints.

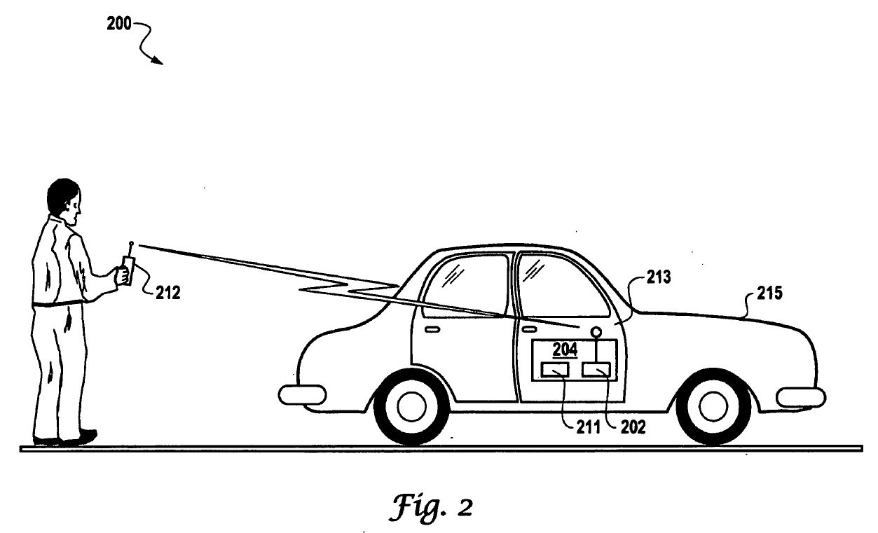

FIG. 2 illustrates a pictorial diagram of a keyless entry system 200, which can be adapted for use in accordance with a preferred embodiment of the present invention. Referring now to the drawings and in particular, to FIG. 2, keyless entry system 200 generally includes a portable remote unit 212 (e.g., a user transmitter) which can transmit data via radio frequency (RF) and/or low frequency (LF) signaling to a vehicle mounted RL/LF unit 202 (i.e., a receiving and transmitting unit), which can communicate with a vehicle latch 211, which is generally analogous to door latch assembly 11 of FIG. 1. Note that LF generally indicates signals in the 30 KHz.about.300 KHz range.

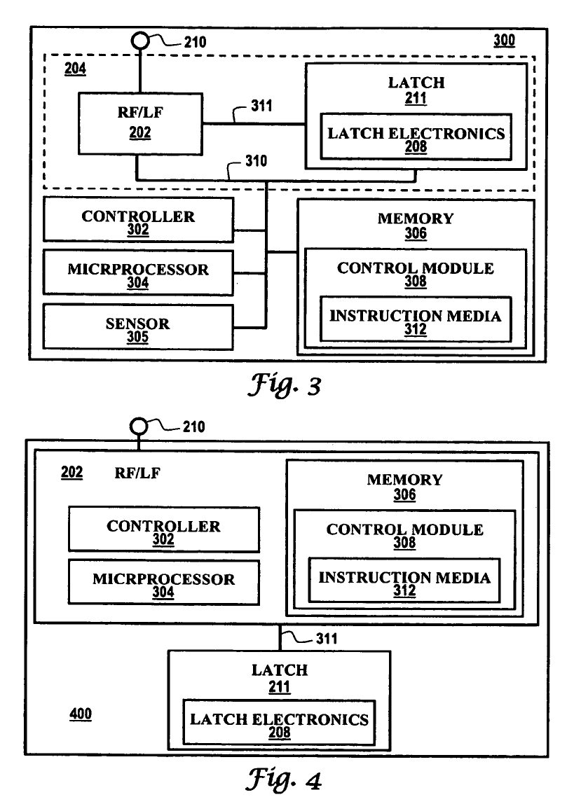

Latch 211 can be mounted within a door 213 of a vehicle 215, which are respectively analogous to vehicle side door 13 and vehicle 15 of FIG. 1. Latch 211 can communicate with RF/LF unit 202 and together can form an integrated RF/LF system 204, which is shown in greater detail in FIG. 3 herein. In general, RF/LF system 204 receives RF and/or LF signals and translates such signals into output control signals. RF/LF system 204 thus receives user commands or instructions from portable remote unit 212. RF/LF unit 202 can therefore interface with latch 211 to perform particular latch functions such as locking or unlocking door 213 (or another door of vehicle 215).

FIG. 3 illustrates a block diagram of a keyless RF/LF system 300, which can be implemented in accordance with a preferred embodiment of the present invention. Note that in FIGS. 2-4, identical parts or elements are indicated by identical reference numerals. System 300 therefore includes latch 211 and latch electronics thereof 208. Latch 211 communicates via RF/LF unit 202 via a communications link 311 or a system bus 310. Note that bus 310 can be implemented as a set of hardware lines (i.e., conductors), which are utilized for data transfer among components of system 300. Bus 310 constitutes a shared communications medium over which the various components of system 300, including a control 302, a microprocessor 304, and a memory 306 can communicate, thereby enabling the transfer of information among such components.

Microprocessor 304 generally can be implemented as central processing unit (CPU) on a single computer chip. Microprocessor 304 therefore functions as the computational and control unit of system 300, and interprets and executes instructions provided to it via bus 310. Microprocessor 304 can fetch, decode, and execute instructions and transfer information to and from other resources of system 300 over bus 310. Controller 302 also receives instructions and data over bus 310 and generally performs an arbitrating or regulating function for system 300. Controller 302 can, for example, control access to memory 306 and act as a control unit for memory 306.

Additionally, a sensor 305 can be implemented with system 300 to provide latch and/or door latch sensing capabilities. Keyless RF/LF system 300 consumes a large amount of power when operating. It is therefore beneficial to shut it down when not in use and reactivate when needed. The reactivation of system 300 can be performed via user input, such as for example, pulling on a car door handle (associated with latch 211), pushing a key fob, and so forth. Sensor 305 can therefore be utilized to detect when a door handle is pulled, and so forth. Sensor 305 can be implemented as any number of types of sensors, such as, for example, Hall, AMR (Anisotropic Magnetoresistive), or optical sensors. Sensor 305 can also be implemented as a capacitive type sensor that is embedded within a door handle such as one associated with door latch assembly 11 depicted in FIG. 1. Sensor 305 generally communicates with various components of system 300 via bus 310.

Memory 306 is connected bus 310, and includes a control module 308 that resides within memory 306 and contains instructions that when executed on microprocessor 304, can carry out logical operations and instructions. Control module 308 can, for example, contain instructions such as those depicted in the flow diagram 500 of FIG. 5 herein. Control module 308 can therefore implement a computer program product. It is important that, while the embodiments have been (and will continue to be) described in the context of a data-processing system such as systems 300 and 400, embodiments are capable of being distributed as a program product in a variety of forms, and that such embodiments can apply, equally regardless of the particular type of signal-bearing media utilized to actually carry out the distribution.

Examples of signal-bearing media include: recordable-type media, such as floppy disks, hard disk drives and CD ROMs, and transmission-type media such as digital and analog communication links. Examples of transmission-type media include devices such as modems. A modem is a type of communications device that enables a computer to transmit information over a standard telephone line. Because a computer is digital (i.e., works with discrete electrical signals representative of binary 1 and binary 0) and a telephone line is analog (i.e., carries a signal that can have any of a large number of variations), modems can be utilized to convert digital to analog and vice-versa. The term “media” as utilized herein is a collective word for the physical material such as paper, disk, CD-ROM, tape and so forth, utilized for storing computer-based information.

Control module 308 can therefore be implemented as a “module” or a group of “modules”. In the computer programming arts, a “module” can be typically implemented as a collection of routines and data structures that performs particular tasks or implements a particular abstract data type. Modules generally are composed of two parts.

First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media. A module can be composed of instruction media 312 which perform particular instructions or user commands, such as unlocking latch 211 and controlling and regulating the interaction between RF/LF unit 202 and latch electronics 208 of latch 211.

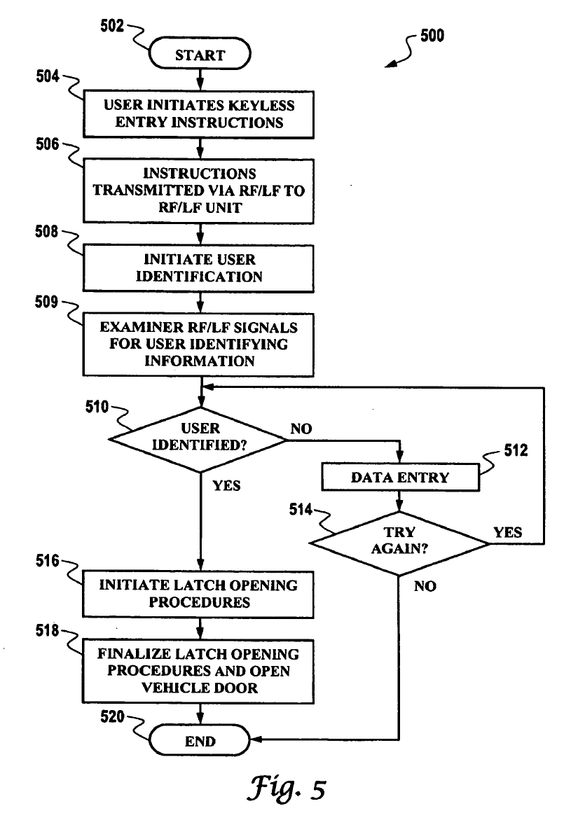

FIG. 4 illustrates a block diagram of a keyless RF/LF system 400, which can be implemented in accordance with an alternative embodiment of the present invention. Note that in FIG. 3 and FIG. 4 identical parts or components are indicated by identical reference numerals. System 400 is thus similar to system 300, but is arranged so that that RF/LF unit 202 actually incorporates components such as controller 302, microprocessor 304, and memory 306.

FIG. 5 illustrates a high-level flow chart 500 of operations depicting logical operational steps which can be implemented in accordance with a preferred embodiment of the present invention. As indicated at block 502, the process is initiated. Thereafter, as indicated at block 504, a user can initiate keyless entry instructions for a vehicle such as vehicle 215 depicted in FIG. 2, utilizing a RF/LF transmitter such as a portable remote unit 212, which is also depicted in FIG. 2. Instructions are then transmitted, as depicted at block 506, to an RF/LF unit, such as, for example RF/LF unit 204 shown FIGS. 2-4 and/or systems 300 or 400 depicted in FIGS. 3-4. Thereafter as depicted at block 509, a user verification process can be initiated in order to ensure that the user transmitting the RF/LF signals and user commands is the proper user. The RF/LF signals can be examined for particular codes which identify the user.

If the user is identified, as indicate at block 510, the process continues. If the user is not identified, then as indicated at block 512, the user is denied entry to the vehicle. The user can be provided with an opportunity, however, to be identified again, and the operation depicted at block 510 can be repeated. If the user does not take advantage of this opportunity, then the process simply terminates, as indicated at block 520. Following a successful processing of the operation depicted at block 510, latch opening procedures can be initiated as depicted at block 516. The latch opening procedures can be finalized and the vehicle door finally opened, as indicated at block 518. The process can then terminate, as indicated at block 520.

Based on the foregoing it can be appreciated that embodiments relate to a keyless entry method, system and program product. In general, user command information can be transmitted to a receiving and transmitting unit which communicates with a latch. A processor can then process the user command information utilizing a processor, which communicates the latch and the receiving and transmitting unit. The latch can thereafter be instructed to perform a particular latch function (e.g., opening or closing a vehicle door), in response to processing the user command information utilizing the processor.

Additionally, the user command information can be analyzed, and a verification test performed to determine if the user initiating the user command is a proper user, based on an analysis of the user command information. For example, if a particular user identifying code is identified among the transmitted user command information, the latch functionality instructions can then be processed. The receiving and transmitting unit can be integrated with the latch. The receiving and transmitting unit can be implemented as an RF/LF unit. By directly connected the latch to the RF/LF unit or system, the latch electronics (e.g., latch electronics 208), which are under software control (i.e., see control module 308 and instruction media 312 thereof), can communicate required functions and/or functionality to the RF/LF unit, thereby permitting the latch to also control the RF/LF unit and/or system.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

What is claimed is:

1. A keyless entry method, comprising the steps of: transmitting user command information to a receiving and transmitting unit which communicates with a latch; processing said user command information utilizing a processor, which communicates said latch and said receiving and transmitting unit; instructing said latch to perform a particular latch function, in response to processing said user command information utilizing said processor.

2. The method of claim 1 further comprising the step of: analyzing said user command information; and verifying that a user initiating said user command is a proper user, based on analyzing said user command information.

3. The method of claim 1 further comprising the step of: integrating said receiving and transmitting unit with said latch.

4. The method of claim 1 wherein said receiving and transmitting unit comprises an RF/LF unit.

5. A keyless entry system, comprising: a user transmitter for transmitting user command information to a receiving and transmitting unit which communicates with a latch; a processor processing said user command information utilizing a processor, which communicates said latch and said receiving and transmitting unit; a control module for instructing said latch to perform a particular latch function, in response to processing said user command information utilizing said processor.

6. The system of claim 5 further comprising: analyzing module for analyzing said user command information; and verification module for verifying that a user initiating said user command is a proper user, based on analyzing said user command information.

7. The system of claim 5 wherein said receiving and transmitting unit is integrated with said latch.

8. The system of claim 5 wherein said receiving and transmitting unit comprises an RF/LF unit.

9. The system of claim 5 wherein said latch comprises latch electronics, which perform particular latch electrical functions based on instructions originating from said control module.

10. The system of claim 9 further comprising a controller, which communicates with said latch, said control module and said microprocessor in order to control said latch electrical functions.

11. The system of claim 10 further comprising a memory, which communicates with said controller, said microprocessor and said latch, and which stores said control module.

12. The system of claim 10 wherein said latch comprises a vehicle door latch embedded within a vehicle door of an automotive vehicle.

13. A program product residing in a data-processing system for implementing keyless entry operations, comprising: instruction media residing in a computer memory for transmitting user command information to a receiving and transmitting unit which communicates with a latch; instruction media residing in a computer memory for processing said user command information utilizing a processor, which communicates said latch and said receiving and transmitting unit; instruction media residing in a computer memory for instructing said latch to perform a particular latch function, in response to processing said user command information utilizing said processor; and wherein each of said instructions means are processed by a processor for managing the control and performance of latch operations.

14. The program product of claim 13 further comprising: instruction media residing in a computer memory for analyzing said user command information; and instruction media residing in a computer memory for verifying that a user initiating said user command is a proper user, based on analyzing said user command information.

15. The program product of claim 13 wherein said receiving and transmitting unit is integrated with said latch.

16. The program product of claim 13 wherein said receiving and transmitting unit comprises an RF/LF unit.

17. The program product of claim 13 further comprising: a controller, which communicates with said latch, said control module and said microprocessor in order to control said latch electrical functions; and a memory, which communicates with said controller, said microprocessor and said latch, and which stores said control module.

18. The program product of claim 13 wherein each of said instruction means further comprises signal bearing media.

19. The program product of claim 18 wherein said signal bearing media further comprises recordable media.

20. The program product of claim 18 wherein said signal bearing media further comprises transmission media.
